(19) United States
(12) Patent Application Publication
(10) Pub. No.: US 2017/0093864 A1
(43) Pub. Date: Mar. 30, 2017

(54) SYSTEMS AND METHODS FOR DETERMINING WHETHER USER IS HUMAN

(71) Applicant: Limited Liability Company Mail.Ru, Moscow (RU)

(72) Inventor: Maxim Vadimovich PESTUN, Moscow (RU)

(21) Appl. No.: 15/190,207

(22) Filed: Jun. 23, 2016

Related U.S. Application Data
(63) Continuation of application No. PCT/RU2013/001201, filed on Dec. 30, 2013.

(51) Int. Cl. H04L 29/06; G06F 21/31; G06F 21/36

(52) U.S. Cl. CPC H04L 63/10; H04L 67/42; H04L 63/0807; G06F 21/36; G06F 21/316

(57) ABSTRACT

Systems and methods for determining whether a user of a computer system accessing or attempting to access an Internet resource is a human without unduly burdening or annoying the user. The user first authenticates with a first online service such a social networking website or any other suitable web portal. When subsequently a second online service needs to verify that the user is a human, the user is asked press a button “I am human” or take any other similar simple action. In response, the first online service provides to the second online service the information on whether the user seeking access thereto is a human. This information may be in a simple “True” or “False” form. No other information is exchanged between the first service and the second service, unlike the conventional systems, which use user's login with the first computer system to authenticate user with the second system.

### BACKGROUND OF THE INVENTION

Field of the Invention

The disclosed embodiments relate in general to the field of computer software and in particular to systems and methods for determining whether the user of a computerized system accessing or attempting to access an Internet resource is a human.

Description of the Related Art

It is often necessary to determine whether a particular Internet resource is being accessed by a human user using a web browser or an automated software application with an Internet access called a robot or “bot”. Differentiating human users from automated software applications is necessary, for example, for preventing automated email account registrations, which could be later used for sending spam, for preventing automated downloading of large amounts of content and for preventing spam messages being automatically posted on social media platforms.

The conventional technology for differentiating human users from automated software applications, called CAPTCHA, involves asking the user to visually parse an image of a distorted alphanumeric string and enter the string characters into a provided input field. The string of characters entered by the user is then sent to a server, where they are compared with the original string. In case of a match, the system determines that the user is a human. The convention technology however suffers from a number of drawbacks. As the computer performance increases, in order to prevent automated recognition of the test text string, it must be made more and more distorted to the point when a human user has difficulty recognizing it. This annoys the user adversely affecting the user experience.

Therefore, new and improved systems and methods for determining whether a user of a computerized system accessing or attempting to access an Internet resource is a human are needed, which would not unduly burden or annoy the user.

### SUMMARY OF THE INVENTION

The inventive methodology is directed to methods and systems that substantially obviate one or more of the above and other problems associated with conventional techniques for determining whether the user of a computer system accessing an Internet resource is a human.

In accordance with one aspect of the embodiments described herein, there is provided a computer-implemented method for verifying whether a user is a human, the computer-implemented method being performed in connection with a server computer system, the server computer system comprising a central processing unit, a network interface and a memory, the computer-implemented method involving: receiving, via the network interface, a request for a resource from a client computer system; in response to the request for the resource, returning, via the network interface, the resource to the client computer system; receiving, via the network interface, a second request from the client computer system, the second request containing user verification data; in response to receiving the second request from the client computer system, sending, via the network interface, a verification request to a trusted server, the verification request comprising the user verification data; receiving, via the network interface, a verification response from the trusted server, the verification response comprising a verification whether a user is the human; and processing the second request from the client computer system based on the verification whether the user is the human.

In one or more embodiments, the verification data comprises a one-time ticket comprising identity information of the user.

In one or more embodiments, the resource comprises an HTML form and a user verification code.

In one or more embodiments, the second request from the client computer system comprises a form submission request in connection with the HTML form.

In one or more embodiments, the verification data comprises a transcribed textual character string.

In one or more embodiments, in response to a third request received from the client computer system, the trusted server is configured to generate a distorted image of an original textual character string and transmit it to the client computer system and wherein the transcribed textual character string is a transcription of the distorted image of the original textual character string.

In one or more embodiments, in response to a third request received from the client computer system, the trusted server is configured to generate a one-time ticket comprising identity information of the user.

In accordance with another aspect of the embodiments described herein, there is provided a non-transitory computer-readable medium embodying a set of computer-readable instructions, which, when executed in connection with a server computer system, the server computer system comprising a central processing unit, a network interface and a memory, cause the server computer system to perform a computer-implemented method involving: receiving, via the network interface, a request for a resource from a client computer system; in response to the request for the resource, returning, via the network interface, the resource to the client computer system; receiving, via the network interface, a second request from the client computer system, the second request containing user verification data; in response to receiving the second request from the client computer system, sending, via the network interface, a verification request to a trusted server, the verification request comprising the user verification data; receiving, via the network interface, a verification response from the trusted server, the verification response comprising a verification whether a user is a human; and processing the second request from the client computer system based on the verification whether the user is the human.

In one or more embodiments, the verification data comprises a one-time ticket comprising identity information of the user.

In one or more embodiments, the resource comprises an HTML form and a user verification code.

In one or more embodiments, the second request from the client computer system comprises a form submission request in connection with the HTML form.

In one or more embodiments, the verification data comprises a transcribed textual character string.

In one or more embodiments, in response to a third request received from the client computer system, the trusted server is configured to generate a distorted image of an original textual character string and transmit it to the client computer system and wherein the transcribed textual character string is a transcription of the distorted image of the original textual character string.

In one or more embodiments, in response to a third request received from the client computer system, the trusted server is configured to generate a one-time ticket comprising identity information of the user.

In accordance with yet another aspect of the embodiments described herein, there is provided a server computer system, the server computer system comprising a central processing unit, a network interface and a memory, the memory comprising a set of instructions for: receiving, via the network interface, a request for a resource from a client computer system; in response to the request for the resource, returning, via the network interface, the resource to the client computer system; receiving, via the network interface, a second request from the client computer system, the second request containing user verification data; in response to receiving the second request from the client computer system, sending, via the network interface, a verification request to a trusted server, the verification request comprising the user verification data; receiving, via the network interface, a verification response from the trusted server, the verification response comprising a verification whether a user is a human; and processing the second request from the client computer system based on the verification whether the user is the human.

In one or more embodiments, the verification data comprises a one-time ticket comprising identity information of the user.

In one or more embodiments, the resource comprises an HTML form and a user verification code.

In one or more embodiments, the second request from the client computer system comprises a form submission request in connection with the HTML form.

In one or more embodiments, the verification data comprises a transcribed textual character string.

In one or more embodiments, in response to a third request received from the client computer system, the trusted server is configured to generate a distorted image of an original textual character string and transmit it to the client computer system and wherein the transcribed textual character string is a transcription of the distorted image of the original textual character string.

In one or more embodiments, in response to a third request received from the client computer system, the trusted server is configured to generate a one-time ticket comprising identity information of the user.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates a logical diagram of an exemplary embodiment of a distributed computerized system for determining whether a user of a computer system accessing or attempting to access an Internet resource is a human without unduly burdening or annoying the user.

FIG. 2 provides a diagram illustrating command and data flows in an exemplary embodiment of a distributed computerized system for determining whether a user of a computer system accessing or attempting to access an Internet resource is a human without unduly burdening or annoying the user.

FIG. 3 illustrates an exemplary operating sequence of an embodiment of a distributed computerized system for determining whether a user of a computer system accessing or attempting to access an Internet resource is a human without unduly burdening or annoying the user.

FIG. 4 illustrates an exemplary user interface of a distributed computerized system for determining whether a user of a computer system accessing or attempting to access an Internet resource is a human without unduly burdening or annoying the user.

FIG. 5 is a block diagram that illustrates an exemplary embodiment of a client portion of the distributed computerized system for determining whether a user of a computer system accessing or attempting to access an Internet resource is a human without unduly burdening or annoying the user.

FIG. 6 is a block diagram that illustrates an exemplary embodiment of a server portion of the distributed computerized system for determining whether a user of a computer system accessing or attempting to access an Internet resource is a human without unduly burdening or annoying the user.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In accordance with one or more embodiments described herein, there are provided systems and methods for determining whether a user of a computer system accessing or attempting to access an Internet resource is a human without unduly burdening or annoying the user. Specifically, in one or more embodiments, the user first authenticates with a first online service such a social networking website or any other suitable and secure web portal. When, subsequently, a second online service needs to verify that the user is a human, the user is asked to activate a button “I am human” or take any other similar simple action. In response, the second online service requests from the first online service and the first online service provides to the second online service the verification of whether the user seeking access thereto is a human. In one or more embodiments, this verification information may be in a simple “True” or “False” form. In one or more embodiments, no other information is exchanged between the first online service and the second online service, unlike the conventional systems, which use user's login with the first computer system to authenticate the user with the second computer system.

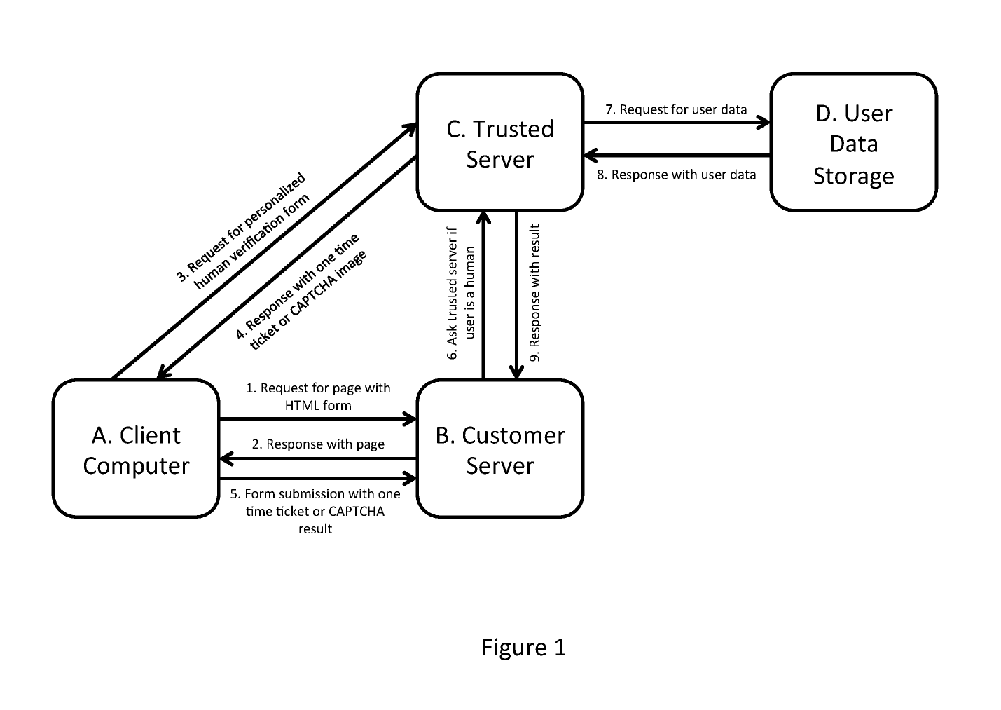

FIG. 1 illustrates a logical diagram of an exemplary embodiment of a distributed computerized system for determining whether a user of a computer system accessing or attempting to access an Internet resource is a human without unduly burdening or annoying the user. The computerized system illustrated in FIG. 1 incorporates a client computer (A), which is a computerized system directly accessible by a human user or a computerized system executing an automated software application attempting to simulate a human user. The customer server (B) is a server, communicatively coupled with the client computer (A) via a computer network, such as Internet. In one or more embodiments, the customer server (B) is a web server operating in conjunction with associated server-side scripts, such as PHP scripts, well known to persons of ordinary skill in the art. In one or more embodiments, the aforesaid web server may be of any known of later developed type, including, without limitation, Apache, Microsoft IIS, nginx, Google GWS, lighttpd and Sun Microsystems SunOne.

In one or more embodiments, the customer server (B) is running software for determining whether the user seeking access to customer server (B) is a human. In one or more embodiments, the customer server (B) receives a request, such as an HTTP request, from the client computer (A) and is configured to provide the information responsive to the received request only if it is determined that the user is a human and reject the request if it is determined that the user is an automated software application.

In one or more embodiments, to facilitate verification that the user is a human, the system shown in FIG. 1 also incorporates a trusted server (C). The trusted server (C) is connected via the network, such as Internet, to the customer server (B). The customer server (B) is configured to communicate with the trusted server (C) via the network in order to verify whether the user is a human. The system further includes a user data storage (D) storing the information about the users who have accounts with the trusted server. The stored information may include users' login credentials, last login times, as well as other information. In one or more embodiments, the data storage (D) is implemented using a database management system, such as a relational database management system well known to persons of ordinary skill in the art. Specifically, the database management system may be of any known of later developed type including, without limitation, Oracle DBMS, Access and SQL Server from Microsoft, DB2 from IBM and the Open source DBMS MySQL. In one or more embodiments, all the data exchanges between the described client and server components of the distributed system shown in FIG. 1 are performed in accordance with HTTP protocol, well known to persons of ordinary skill in the art. Data exchange between the trusted server and the data storage may be performed using one of a number of database protocols also well known to persons of ordinary skill in the art.

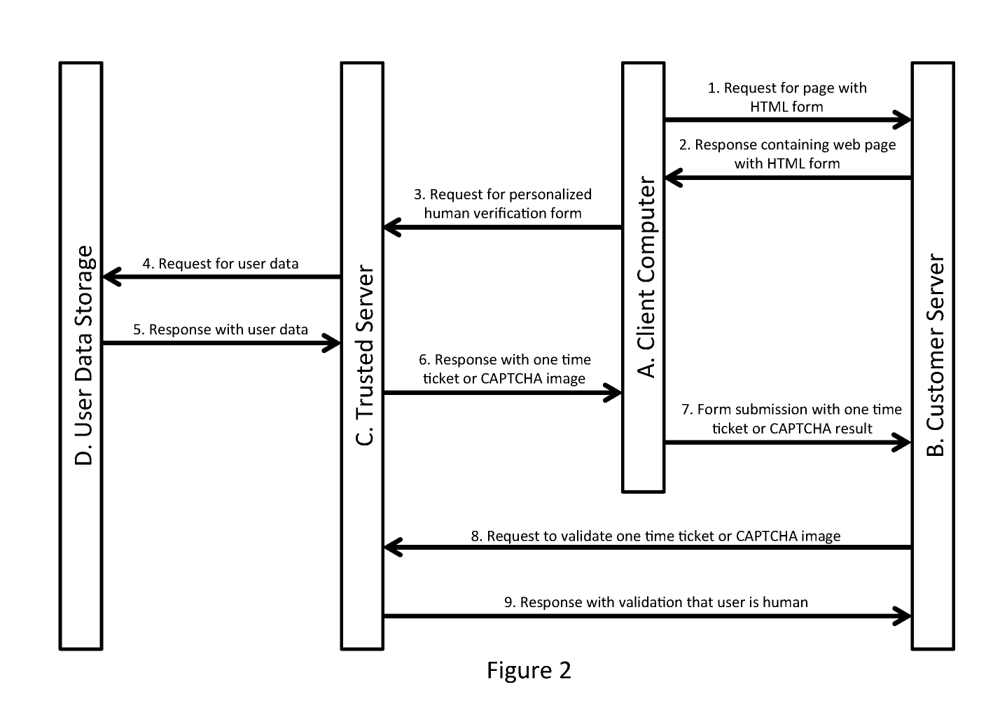

The data and command flows between various components of the distributed computerized system for determining whether a user of a computer system accessing or attempting to access an Internet resource is a human will now be described with reference to FIG. 1 and FIG. 2. Initially, the client computer directly accessible by a user sends request 1 for a resource, such as a web page, from the customer server. In one embodiment, the requested resource is a web page with a HTML form that the user is prompted to fill in. The customer server is configured to require a confirmation that the user is a human to process the submission of the aforesaid HTML form by the user. In one embodiment, the HTML form is a user registration form. In one or more embodiments, the form submission may be performed using GET and POST requests of HTTP protocol well known to persons of ordinary skill in the art.

The customer server sends response 2 to the client computer containing the requested resource and incorporating a block of code for facilitating verification that the user is a human. Upon receiving the response 2 from the customer server, the client computer sends request 3 to the trusted server for additional data with respect to the user. In one or more embodiments, the request 3 is based, at least in part, on the block of code received from the customer server as a part of the response 2.

After receiving the request 3, the trusted server (C) sends a response 4 to the client computer. In one or more embodiments, the response 4 may be in a form of an HTML page containing an HTML form well known to persons of ordinary skill in the art. If the user has been previously registered with the trusted server, the response 4 may contain a one-time ticket identifying the user. Otherwise, or if the user's online behavior is suspicious, the response 4 contains a CAPTCHA image described above. To determine whether of not the user behaves suspiciously, the trusted server is configured to monitor user's online behavior. In one exemplary embodiment, the trusted server is part of social networking platform. It may be configured to monitor user's activity on the social networking platform, such as user's accessing other user's profiles, in order to determine whether the user acts suspiciously (e.g. the user is a suspected automated software application).

The HTML page received from the trusted server is displayed to the user on the display device of the client computer. The displayed HTML page contains an HTML form that prompts the user to either decode the CAPTCHA or to press a button “I am human.” When the user submits the HTML form embedded into the displayed HTML page, the one-time ticket or the CAPTCHA string transcoded by the user (5) is sent to the customer server. The customer server, in response, sends request 6 to the trusted server, which includes the one-time ticket or the CAPTCHA string. After receiving the request 6, the trusted server sends a request 7 to the user data storage (D) for the user data associated with the user identified in the request 6. The user data storage responds to the trusted server with a user data 8. Based on this information, the trusted server sends response 9 to the customer server informing the customer server whether or not the user is a human. In an alternative embodiment, no “I am human” button is provided and the system performs the verification automatically. In this case, the message confirming verification may also be displayed.

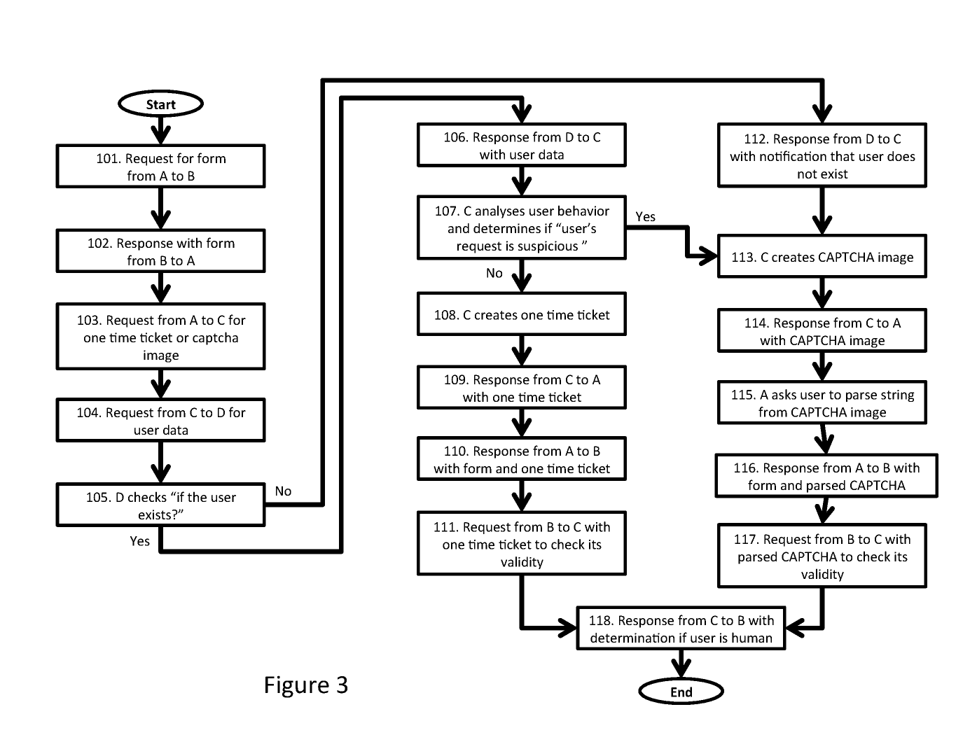

FIG. 3 illustrates an exemplary operating sequence of an embodiment of a distributed computerized system for determining whether a user of a computer system accessing or attempting to access an Internet resource is a human without unduly burdening or annoying the user. First, at step 101, the client computer sends a request to the customer server for the HTML page containing an HTML form including at least one input data field. In an alternative embodiment, the client computer may request from the customer server any other content, such as a downloadable file. At step 102, the customer server responds with the requested HTML page form back to the client computer. At step 103, the client computer sends a request for one-time ticket or a CAPTCHA image described above to the trusted server. In response, at step 104, the trusted server sends a request for user data to the user data storage. Upon receiving this request, the user data storage checks whether the data records for the user exist. If the user information does not exist in the user data storage, at step 112 the user data storage sends a response to the trusted server notifying it that the user data does not exist. At step 113, the trusted server creates a CAPTCHA image described above. At step 114, the trusted server sends back a response containing the generated CAPTCHA image to the client computer. At step 115, the client computer displays the CAPTCHA image to the user and asks the user to input the decoded alphanumeric string. At step 116, the client computer receives from the user the HTML form with information input by the user and sends it to the customer server together with the CAPTCHA string input by the user. At step 117, in response to receiving the CAPTCHA string from the client computer, the customer server sends the CAPTCHA string to the trusted server. The trusted server responds at step 118 to the customer server with the results of verification, based on the CAPTCHA string, of whether the user is a human.

On the other hand, if it is determined at step 105 that the data records for the user exist, then, at step 106, the user data storage sends a response to the trusted server. In one or more embodiments, the aforesaid response contains user data retrieved from the user data storage based on the received request. Subsequently, at step 107, the trusted server analyses the behavior of the user and determines whether or not the user's request is suspicious. If so, the control is passed to step 113 described above.

If the user behavior is deemed to be not suspicious, then at step 108, the trusted server creates a one-time ticket. At step 109, the trusted server sends a response with the created one-time ticket to the client computer. The client computer receives the one-time ticket sent by the trusted server and, at step 110, sends a response containing the HTML form with information input by the user and the one-time ticket to the customer server. At step 111, the customer server sends a request to the trusted server containing the one-time ticket to verify its validity. Finally, at step 118, the trusted server responds to the customer server with the results of verification, based on the one-time ticket or the CAPTCHA algorithm, of whether the user is a human. Subsequently, the HTML form submission request received from the client computer is processed by the customer server based on the results of the verification of whether the user is a human. In one or more embodiments, the HTML form submission request is rejected if it is determined that the user is not a human.

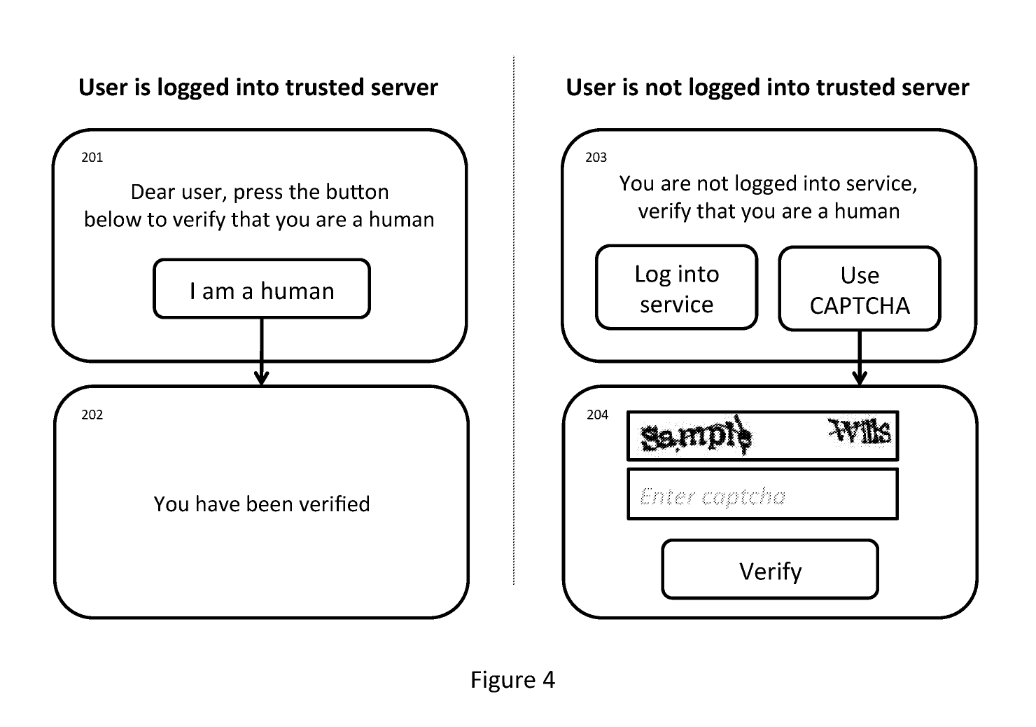

FIG. 4 illustrates exemplary embodiments of a user interface of a client portion of the distributed computerized system for determining whether a user of a computer system accessing or attempting to access an Internet resource is a human without unduly burdening or annoying the user. In one or more embodiments, the embodiments of the user interface shown in FIG. 4 are web-based user interfaces, which are generated on the screen of the client computer using a web browser. If the user is logged in into the trusted system, such as a social network, the user is shown user interface 201. Specifically, the user is asked to press a button “I am human.”. Once the button “I am human” is pressed, interface screen 202 is shown confirming that the system has successfully verified that the user is human. In an alternative embodiment, the “I am human” button is not provided and the verification is performed automatically.

On the other hand, if the user is not logged in into the trusted system, the interface 203 is displayed in the user's browser. The user is advised that the system need to verify that the user is a human and the user is provided with two options for such verification. Specifically, the user may press “Log into service” button and login into the trusted server. After that, the verification is completed as described above in connection with FIG. 3 and the screen 202 is shown. Alternatively, the user may activate “Use captcha” button and be provided with the interface screen 204 prompting the user to enter the CAPTCHA string and press the “Verify” button. Once the “Verify” button is pressed, the user is verified using the entered CAPTCHA string as described in detail above with reference to FIG. 3. In an alternative embodiment, the “Verify” button is not provided and the verification is performed automatically when the HTML form is submitted by the user.

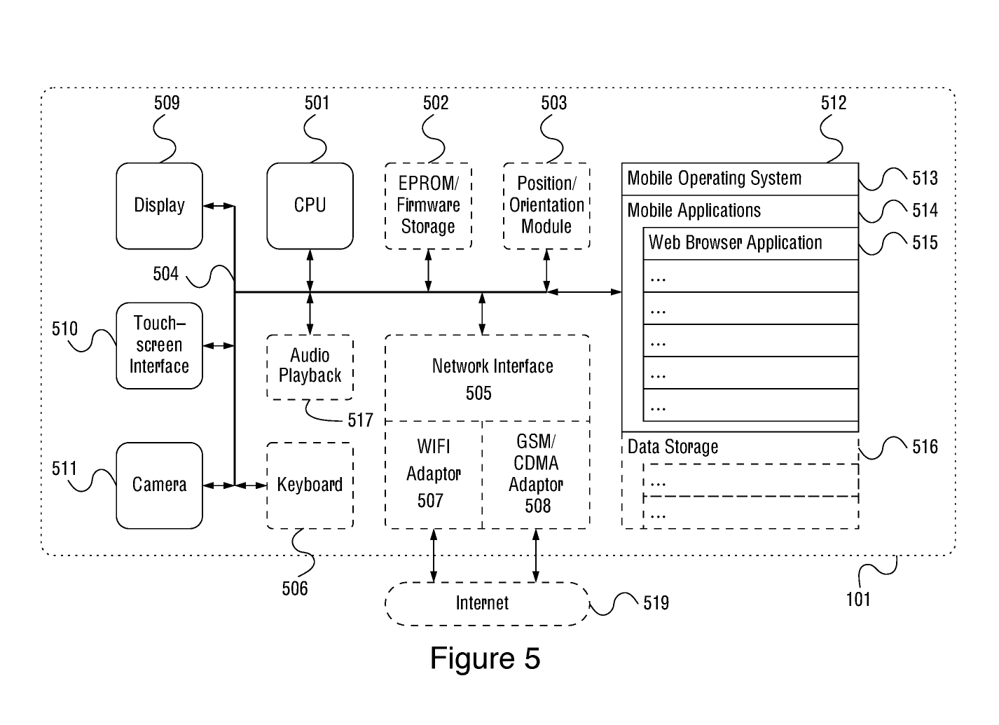

FIG. 5 is a block diagram that illustrates an exemplary embodiment of the client computer 500 representing the client portion of the distributed computerized system for determining whether a user of a computer system accessing or attempting to access an Internet resource is a human without unduly burdening or annoying the user. In one or more embodiments, the client computer 500 may be implemented within the form factor of a mobile computing device, such as a smartphone, a personal digital assistant (PDA), or a tablet computer, all of which are available commercially and are well known to persons of skill in the art. In an alternative embodiment, the client computer 500 may be implemented based on a desktop, a laptop or a notebook computer. Yet in an alternative embodiment, the client computer 500 may be an embedded system, incorporated into an electronic device with certain specialized functions, such as an electronic book (or e-book) reader. Yet in an alternative embodiment, the client computer 500 may be implemented as a part of an augmented reality head-mounted display (HMD) systems, also well known to persons of ordinary skill in the art.

The client computer 500 may include a data bus 504 or other interconnect or communication mechanism for communicating information across and among various hardware components of the client computer 500, and a central processing unit (CPU or simply processor) 501 coupled with the data bus 504 for processing information and performing other computational and control tasks. Client computer 500 also includes a memory 512, such as a random access memory (RAM) or other dynamic storage device, coupled to the data bus 504 for storing various information as well as instructions to be executed by the processor 501. The memory 512 may also include persistent storage devices, such as a magnetic disk, optical disk, solid-state flash memory device or other non-volatile solid-state storage devices.

In one or more embodiments, the memory 512 may also be used for storing temporary variables or other intermediate information during execution of instructions by the processor 501. Optionally, client computer 500 may further include a read only memory (ROM or EPROM) 502 or other static storage device coupled to the data bus 504 for storing static information and instructions for the processor 501, such as firmware necessary for the operation of the client computer 500, basic input-output system (BIOS), as well as various configuration parameters of the client computer 501.

In one or more embodiments, the client computer 500 may incorporate a display device 509, which may be also coupled to the data bus 504, for displaying various information to a user of the client computer 500. In an alternative embodiment, the display 509 may be associated with a graphics controller and/or graphics processor (not shown). The display device 509 may be implemented as a liquid crystal display (LCD), manufactured, for example, using a thin-film transistor (TFT) technology or an organic light emitting diode (OLED) technology, both of which are well known to persons of ordinary skill in the art. In various embodiments, the display device 509 may be incorporated into the same general enclosure with the remaining components of the client computer 500. In an alternative embodiment, the display device 509 may be positioned outside of such enclosure.

In one or more embodiments, the display device 509 may be implemented in a form of a projector or a mini-projector configured to project information on various objects, such as glasses worn by the user. In one or more embodiments, the display device 509 may be configured to be mountable on the head of the user. To this end, the display device 509 may be provided with suitable mounting hardware (not shown).

In one or more embodiments, the client computer 500 may further incorporate an audio playback device 517 connected to the data bus 504 and configured to play various audio files, such as MPEG-3 files, or audio tracks of various video files, such as MPEG-4 files, well known to persons of ordinary skill in the art. To this end, the client computer 500 may also incorporate waive or sound processor or a similar device (not shown).

In one or more embodiments, the client computer 500 may incorporate one or more input devices, such as a touchscreen interface 510 for receiving user's tactile commands, a camera 511 for acquiring still images and video of various objects, as well as a keyboard 506, which all may be coupled to the data bus 504 for communicating information, including, without limitation, images and video, as well as user command selections to the processor 501. In an alternative embodiment, input devices may include a system for tracking eye movements of the user (not shown), which may be used to indicate to the client computer 500 the command selection made by the user.

In one or more embodiments, the client computer 500 may additionally include a positioning and orientation module 503 configured to supply data on the current geographical position, spatial orientation as well as acceleration of the client computer 500 to the processor 501 via the data bus 504. The geographical position information may be obtained by the positioning module 503 using, for example, global positioning system (GPS) technology and/or other positioning techniques such as by using information provided by proximate cell towers and/or WIFI hotspots. The acceleration data is supplied by one or more accelerometers incorporated into the positioning and orientation module 503. Finally, the orientation information may be obtained using acceleration measurements in all 3 axes, including the gravity. In one or more embodiments, the position, orientation and acceleration metadata provided by the positioning and orientation module 503 is continuously recorded and stored in the data storage unit 516.

In one or more embodiments, the client computer 500 may additionally include a communication interface, such as a network interface 505 coupled to the data bus 504. The network interface 505 may be configured to establish a connection between the client computer 500 and the Internet 519 using at least one of WIFI interface 507 and the cellular network (GSM or CDMA) adaptor 508. The network interface 505 may be configured to provide a two-way data communication between the client computer 500 and the Internet 519. The WIFI interface 507 may operate in compliance with 802.11a, 802.11b, 802.11g and/or 802.11n protocols as well as Bluetooth protocol well known to persons of ordinary skill in the art. In an exemplary implementation, the WIFI interface 507 and the cellular network (GSM or CDMA) adaptor 508 send and receive electrical or electromagnetic signals that carry digital data streams representing various types of information.

In one or more embodiments, the Internet 519 typically provides data communication through one or more sub-networks to other network resources. Thus, the client computer 500 is capable of accessing a variety of network resources located anywhere on the Internet 519, such as remote media servers, web servers, other content servers as well as other network data storage resources. In one or more embodiments, the client computer 500 is configured send and receive messages, media and other data, including application program code, through a variety of network(s) including Internet 519 by means of the network interface 505. In the Internet example, when the client computer 500 acts as a network client, it may request code or data for an application program executing on the client computer 500. Similarly, it may send various data or computer code to other network resources.

In one or more embodiments, the functionality described herein is implemented by client computer 500 in response to processor 501 executing one or more sequences of one or more instructions contained in the memory 512. Such instructions may be read into the memory 512 from another computer-readable medium. Execution of the sequences of instructions contained in the memory 512 causes the processor 501 to perform the various process steps described herein. In alternative embodiments, hard-wired circuitry may be used in place of or in combination with software instructions to implement the embodiments invention. Thus, embodiments of the invention are not limited to any specific combination of hardware circuitry and software.

The term “computer-readable medium” as used herein refers to any medium that participates in providing instructions to processor 501 for execution. The computer-readable medium is just one example of a machine-readable medium, which may carry instructions for implementing any of the methods and/or techniques described herein. Such a medium may take many forms, including but not limited to, non-volatile media and volatile media.

Common forms of non-transitory computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read. Various forms of computer readable media may be involved in carrying one or more sequences of one or more instructions to processor 501 for execution. For example, the instructions may initially be carried on a magnetic disk from a remote computer. Alternatively, a remote computer can load the instructions into its dynamic memory and send the instructions over the Internet 519. Specifically, the computer instructions may be downloaded into the memory 512 of the client computer 500 from the foresaid remote computer via the Internet 519 using a variety of network data communication protocols well known in the art.

In one or more embodiments, the memory 512 of the client computer 500 may store any of the following software programs, applications or modules:

1. Operating system (OS) 513, which may be a mobile operating system for implementing basic system services and managing various hardware components of the client computer 500. Exemplary embodiments of the operating system 513 include, without limitation, Mac OS, Windows, Android, iOS, Windows and Windows Mobile and Linux, which are all well known to persons of skill in the art, as well as any other now known or later developed operating system.

2. Applications 514, which may be mobile applications, may include, for example, a set of software applications executed by the processor 501 of the client computer 500, which cause the client computer 500 to perform certain predetermined functions, such as acquire digital images using the camera 511 or play media files using the display 509 and/or an audio playback device 520. In one or more embodiments, the applications 514 may include a web browser application 515.

3. Data storage 516 may be used, for example, for storing various data necessary for the operation of the client computer 500.

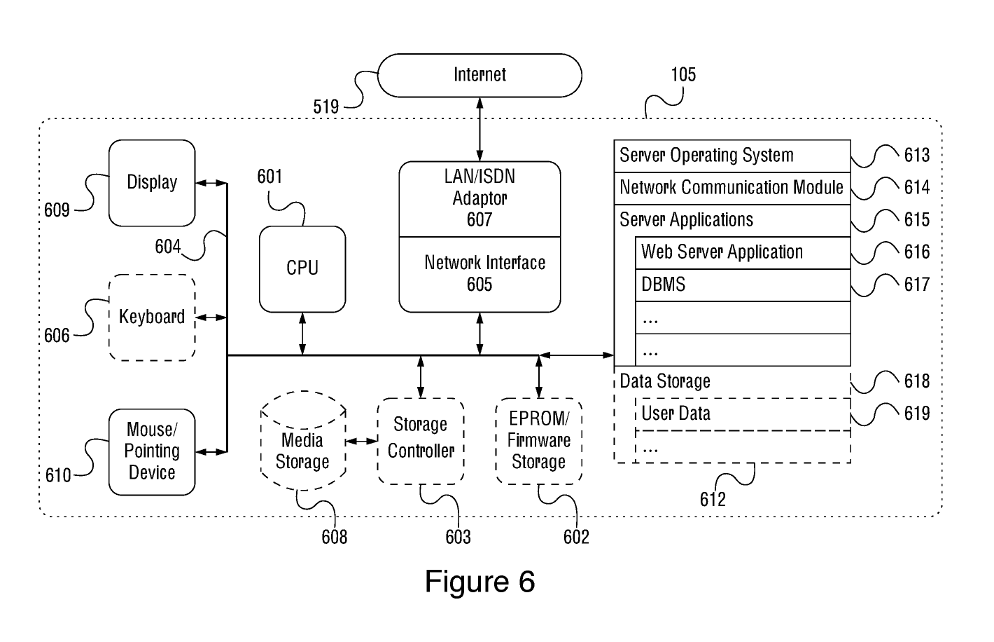

FIG. 6 is a block diagram that illustrates an exemplary embodiment of the computerized server system 600 representing server portion(s) of the distributed computerized system for determining whether a user of a computer system accessing or attempting to access an Internet resource is a human without unduly burdening or annoying the user. Specifically, the customer server and/or the trusted server described above may be deployed on the aforesaid computerized server system 600.

In one or more embodiments, the computerized server system 600 may incorporate a data bus 604, which may be substantially similar and may perform substantially similar functions as the data bus 504 of the client computer 500 illustrated in FIG. 5. In various embodiments, the data bus 604 may use the same or different interconnect and/or communication protocol as the data bus 504. The one or more processors (CPUs) 601, the network interface 605, the EPROM/Firmware storage 602, the display 609 and the keyboard 606 of the computerized server system 600 may be likewise substantially similar to the respective processor 501, the network interface 505, the EPROM/Firmware storage 502, the display 509 and the keyboard 506 of the client computer 500, except that the former components are deployed in a server platform configuration. In various implementations, the one or more processor 601 may have substantially increased processing power as compared with the processor 501.

In addition to the input device 606 (keyboard), the computerized server system 600 may additionally include a cursor control device 610, such as a mouse, a trackball, or cursor direction keys for communicating direction information and command selections to processor 601 and for controlling cursor movement on the display 609. This input device typically has two degrees of freedom in two axes, a first axis (e.g., x) and a second axis (e.g., y), that allows the device to specify positions in a plane.

The LAN/ISDN adaptor 607 of the computerized server system 600 may be implemented, for example, using an integrated services digital network (ISDN) card or a modem to provide a data communication connection to a corresponding type of telephone line, which is interfaced with the Internet 519 using Internet service provider's hardware (not shown). As another example, the LAN/ISDN adaptor 607 may be a local area network interface card (LAN NIC) to provide a data communication connection to a compatible LAN and the Internet 519. To store various media files, the computerized server system 600 may be provided with a media storage 608 connected to the data bus 604 by means of a storage controller 603.

In one or more embodiments, the memory 612 of the computerized server system 600 may store any of the following software programs, applications or modules:

1. Server operating system (OS) 613, which may be an operating system for implementing basic system services and managing various hardware components of the computerized server system 600. Exemplary embodiments of the server operating system 613 include, without limitation, Linux, Unix, Windows Server, FreeBSD, NetBSD, Mac OSX Server, HP-UX, AIX and Solaris, which are all well known to persons of skill in the art, as well as any other now known or later developed operating system.

2. Network communication module 614 may incorporate, for example, one or more network protocol stacks which are used to establish a networking connection between the computerized server system 600 and the various network entities of the Internet 519, such as the client computer 500, using the network interface 605 working in conjunction with the LAN/ISDN adaptor 607.

3. Server applications 615 may include, for example, a set of software applications executed by one or more processors 601 of the computerized server system 600, which cause the computerized server system 600 to perform certain predetermined functions or tasks. In one or more embodiments, the server applications 615 may include a web server application 616 and a database management system (DBMS) 617 comprising a set of software programs enabling storage, modification, and extraction of various data, such as user data. The database management system 617 may be implemented based on any now known or later developed type of database software, such as a relational database management system, including, without limitation, MySQL, Oracle, SQL Server, DB2, SQL Anywhere, PostgreSQL, SQLite, Firebird and/or MaxDB, which are well-known to persons of skill in the art. In an alternative embodiment, a cloud-based distributed database, such as Amazon Relational Database Service (Amazon RDS), well known to persons of ordinary skill in the art, may also be used to implement the database management system 617. In one or more embodiments, the aforesaid web server application 616 may be of any known of later developed type, including, without limitation, Apache, Microsoft IIS, nginx, Google GWS, lighttpd and Sun Microsystems SunOne.

4. Data storage 618 may be used, for example, for storing database tables managed by the database management system 617. The information stored in the aforesaid database tables may include, for example, the user data 619.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the computerized systems and methods for determining whether the user of a computer system accessing or attempting to access an Internet resource is a human. It is intended that the specification and examples be considered as exemplary only, with a true scope and spirit of the invention being indicated by the following claims.

What is claimed is:

1. A computer-implemented method for verifying whether a user is a human, the computer-implemented method being performed in connection with a server computer system, the server computer system comprising a central processing unit, a network interface and a memory, the computer-implemented method comprising:
a. receiving, via the network interface, a request for a resource from a client computer system;
b. in response to the request for the resource, returning, via the network interface, the resource to the client computer system;
c. receiving, via the network interface, a second request from the client computer system, the second request containing user verification data;
d. in response to receiving the second request from the client computer system, sending, via the network interface, a verification request to a trusted server, the verification request comprising the user verification data;
e. receiving, via the network interface, a verification response from the trusted server, the verification response comprising a verification whether a user is the human; and
f. processing the second request from the client computer system based on the verification whether the user is the human.

2. The computer-implemented method of claim 1, wherein the verification data comprises a one-time ticket comprising identity information of the user.

3. The computer-implemented method of claim 1, wherein the resource comprises an HTML form and a user verification code.

4. The computer-implemented method of claim 3, wherein the second request from the client computer system comprises a form submission request in connection with the HTML form.

5. The computer-implemented method of claim 1, wherein the verification data comprises a transcribed textual character string.

6. The computer-implemented method of claim 1, wherein in response to a third request received from the client computer system, the trusted server is configured to generate a distorted image of an original textual character string and transmit it to the client computer system and wherein the transcribed textual character string is a transcription of the distorted image of the original textual character string.

7. The computer-implemented method of claim 1, wherein in response to a third request received from the client computer system, the trusted server is configured to generate a one-time ticket comprising identity information of the user.

8. A non-transitory computer-readable medium embodying a set of computer-readable instructions, which, when executed in connection with a server computer system, the server computer system comprising a central processing unit, a network interface and a memory, cause the server computer system to perform a computer-implemented method comprising:
a. receiving, via the network interface, a request for a resource from a client computer system;
b. in response to the request for the resource, returning, via the network interface, the resource to the client computer system;
c. receiving, via the network interface, a second request from the client computer system, the second request containing user verification data;
d. in response to receiving the second request from the client computer system, sending, via the network interface, a verification request to a trusted server, the verification request comprising the user verification data;
e. receiving, via the network interface, a verification response from the trusted server, the verification response comprising a verification whether a user is a human; and
f. processing the second request from the client computer system based on the verification whether the user is the human.

9. The non-transitory computer-readable medium of claim 8, wherein the verification data comprises a one-time ticket comprising identity information of the user.

10. The non-transitory computer-readable medium of claim 8, wherein the resource comprises an HTML form and a user verification code.

11. The non-transitory computer-readable medium of claim 10, wherein the second request from the client computer system comprises a form submission request in connection with the HTML form.

12. The non-transitory computer-readable medium of claim 8, wherein the verification data comprises a transcribed textual character string.

13. The non-transitory computer-readable medium of claim 8, wherein in response to a third request received from the client computer system, the trusted server is configured to generate a distorted image of an original textual character string and transmit it to the client computer system and wherein the transcribed textual character string is a transcription of the distorted image of the original textual character string.

14. The non-transitory computer-readable medium of claim 8, wherein in response to a third request received from the client computer system, the trusted server is configured to generate a one-time ticket comprising identity information of the user.

15. A server computer system, the server computer system comprising a central processing unit, a network interface and a memory, the memory comprising a set of instructions for:
a. receiving, via the network interface, a request for a resource from a client computer system;
b. in response to the request for the resource, returning, via the network interface, the resource to the client computer system;
c. receiving, via the network interface, a second request from the client computer system, the second request containing user verification data;
d. in response to receiving the second request from the client computer system, sending, via the network interface, a verification request to a trusted server, the verification request comprising the user verification data;
e. receiving, via the network interface, a verification response from the trusted server, the verification response comprising a verification whether a user is a human; and
f. processing the second request from the client computer system based on the verification whether the user is the human.

16. The server computer system of claim 15, wherein the verification data comprises a one-time ticket comprising identity information of the user.

17. The server computer system of claim 15, wherein the resource comprises an HTML form and a user verification code.

18. The server computer system of claim 17, wherein the second request from the client computer system comprises a form submission request in connection with the HTML form.

19. The server computer system of claim 15, wherein the verification data comprises a transcribed textual character string.

20. The server computer system of claim 15, wherein in response to a third request received from the client computer system, the trusted server is configured to generate a distorted image of an original textual character string and transmit it to the client computer system and wherein the transcribed textual character string is a transcription of the distorted image of the original textual character string.
